(19) United States
(12) Patent Application Publication
(10) Pub. No.: US 2023/0147652 A1
(43) Pub. Date: May 11, 2023

(54) INTERACTIVE SLOW FEEDER

(71) Applicant: Lynnette Elaine Methner, Phoenix, AZ (US)

(72) Inventor: Lynnette Elaine Methner, Phoenix, AZ (US)

(21) Appl. No.: 17/520,335

(22) Filed: Nov. 5, 2021

(51) Int. Cl. A01K 5/01; A01K 15/02

(52) U.S. Cl. CPC A01K 5/0142; A01K 15/025

(57) ABSTRACT

An interactive slow feeder is provided. The feeder requires intellectual assessment and physical interaction by a horse or other animal to access forage or other suitable feed contained within a feed box, which is closed by a cover and placed on the ground or barn floor to simulate a grazing position. The interactive slow feeder encourages the animal to engage in natural, interactive feeding behaviors, simulates the experience of grazing, combats boredom, and tends to discourage overeating.

### BACKGROUND OF THE INVENTION

### Technical Field

The disclosures herein relate to animal feeder devices. Specifically, the disclosed invention relates to an interchangeable interactive slow feeder device for large herbivorous animals, particularly horses, which requires ongoing interaction by the animal with interchangeable features of the device to access hay or other feed.

### State of the Art

The natural feeding behavior of horses and many other large herbivorous animals is well-established. Typically, a horse will spend between fifty and sixty percent of its time during a 24-hour day eating. In fact, the natural feeding process is, more-or-less, continuous during daylight hours. Horses and large herbivorous animals feed naturally by grazing. Grazing is an instinctive, established evolutionary process involving differing levels of instinctive and cognitive responses and behavior which culminate in the consumption of food. For example, a grazing animal may consider the distribution of different species of plant in an area, accessibility of the terrain, and the geographical location of forage in relation to water, shade, protection from wind, and bedding sites. Additionally, an animal is guided by its changing physiological needs, such as hunger, thirst, thermal regulation, energy level/fatigue, and the like. Actual food consumption involves sensory investigation (i.e., smell and touch) of the forage, biting off a portion of forage, and then taking one or two steps forward while chewing.

In an open pasture, horses, for example for example, directly consume growing forage, such as grasses and soft non-woody plants, feeding with its head down and its nose brushing against the forage very near the ground. Such grazing behavior is a stepwise process wherein the animal may typically spend hours in a head-down position with its nose within inches of the ground as it investigates, bites, and chews the forage while slowly moving step-by-step across the ground.

Imbalances in physical and psychological aspects of this system, such caused by feeding from a trough or similar fixed-position open feeder, disrupt a horse's natural, instinctive grazing behavior and create boredom. This can result in overfeeding or underfeeding. Additionally, placing hay or other forage on the ground increases the risk of “sand colic,” abdominal pain in horses from ingesting sand. This abdominal pain arises from irritation of the colon of horses caused by the accumulation of sand. Colic can also arise from eating too fast, another risk that is increased when using an open feeder.

Moreover, existing devices for feeding horses and other grazing animals are problematic with respect to preservation of instinctive and cognitive feeding experiences important for optimal animal health. Feeding troughs and corral fence-mounted feeders do not place the horse in proper maximal “head-down” feeding position to replicate the natural grazing experience. Feeders mounted on the side of a fence can be awkward to load with hay, resulting in spilling hay onto the ground outside of the corral. All open feeders allow the horse to access its food freely with minimal or no interaction, unlike the natural grazing experience. An absence of interactive feeding behaviors may create boredom, overeating, and eating too quickly.

For at least the foregoing issues, the use of existing feeders for horses does not encourage the animal to engage in natural, interactive feeding behaviors, deprives the animal of forage interaction similar to grazing, often results in overeating, and may lead to multiple metabolic and psychological stresses that ultimately negatively impact the animal's health.

Because of these and other problems, there is a need for an improved feeder design for use in feeding large, domesticated herbivorous animals, such as horses, that addresses the aforementioned deficiencies.

### BRIEF SUMMARY OF THE INVENTION

Disclosed herein are embodiments of an interactive slow feeder for feeding domesticated large animals, such as horses. The interactive slow feeder incorporates a relatively simple design. The device rests on the ground, can be easily filled with hay, and incorporates interchangeable features that require animal interaction for a horse or other grazing animal to access hay or other feed.

Disclosed is an interactive slow feeder comprising a feed box having an interior defined by at least one side and configured to hold an animal feed; a cover configured to moveably interact with the at least one side to fully enclose the interior and having a feed port in communication with the interior; and a feature operatively coupled to the feed port, wherein the feature is configured to change the feed port between a closed position restricting access to the interior to an open position allowing access to the interior in response to an animal interaction with the feature, wherein the animal may remove the animal feed from the interior.

In some embodiments, the interactive slow feeder further comprises a bottom coupled to the at least one side opposite the cover. In some embodiments, the cover has a plurality of feed ports. In some embodiments, the cover is hingedly coupled to the at least one side. In some embodiments, the cover is slidably coupled to the at least one side. In some embodiments, the cover is hingedly coupled to the at least one side. In some embodiments, the cover is slidably coupled to the at least one side. In some embodiments, the cover is removable from the feed box.

In some embodiments, the interactive slow feeder has a plurality of features. In some embodiments, each of the plurality of features is operatively coupled to only one of the plurality of feed ports. In some embodiments, at least one of the plurality of features is operatively coupled to more than one of the plurality of feed ports. In some embodiments, the plurality of features is operatively coupled to more than one of the plurality of feed ports.

In some embodiments, the feature is a flap covering the feed port and formed by a flexible lower element partially overlapping or overlapped by a flexible upper element. In some embodiments, the flap has a substantially linear edge. In some embodiments, the flap has a substantially arcuate edge.

In some embodiments, the feature is slidably coupled to the opening. In some embodiments, the feature is hingedly coupled to the opening.

In some embodiments, the feature comprises an animal toy.

Also disclosed is a method of simulating a grazing experience for a horse.

The foregoing and other features and advantages of the invention will be apparent to those of ordinary skill in the art from the following more particular description of the invention and the accompanying drawings.

### BRIEF DESCRIPTION OF THE DRAWINGS

FIGS. 1A-B are top-side perspective and top views of an embodiment of an interactive slow feeder;

FIG. 2 is a bottom view of an embodiment of an interactive slow feeder;

FIG. 3 is a rear view of an embodiment of an interactive slow feeder;

FIG. 4 is a front view of an embodiment of an interactive slow feeder;

FIG. 5 is an underside perspective view of an embodiment of a cover for an interactive slow feeder;

FIGS. 6A-B are top-side perspective and top views of an embodiment of an interactive slow feeder having cover features in a box-grid configuration;

FIGS. 7A-B are top-side perspective and top views of an embodiment of an interactive slow feeder having ball features;

FIGS. 8A-B are top-side perspective and top views of an embodiment of an interactive slow feeder with a cover having slide features;

FIGS. 9A-B are top-side perspective and top views of an embodiment of an interactive slow feeder with a cover having roller features; and

FIG. 10 is a diagram of steps of a method of simulating a grazing experience to fa horse.

### DETAILED DESCRIPTION

Various example embodiments of an interactive slow feeder are described in detail herein. The feeder includes a feed-box container having an interior which can be filled with hay or other forage. The feed-box container has a bottom and is placed on the ground or on the floor of a barn or other building structured where horses or livestock are kept. Placement of the feed-box container on the ground requires the grazing animal, such as a horse, to feed with its head in a position proximate to the ground, requiring the animal to assume natural feeding posture, such as when grazing.

The container is fitted with a removable cover having at least one feed port. The feed port is completely or partially obstructed by a moveable feature, such as a flap, a slider, or other movable obstruction. To access forage from the interior of the closed container through a feed port, an animal, such as a horse, must determine how to interact with the movable feature obstructing the feed port, opening the feed port to allow access to the forage held in the interior of the feed box. Different types of movable features appear differently to the horse, may have different action mechanisms, and require the horse to determine how to move the feature. The cover may have several feed ports with each feed port bearing similar or different moveable feature types with respect to other feed ports. Furthermore, a cover interchangeable with different covers bearing different feed ports may be exchanged on the feed box, in some embodiments of the interactive slow feeder.

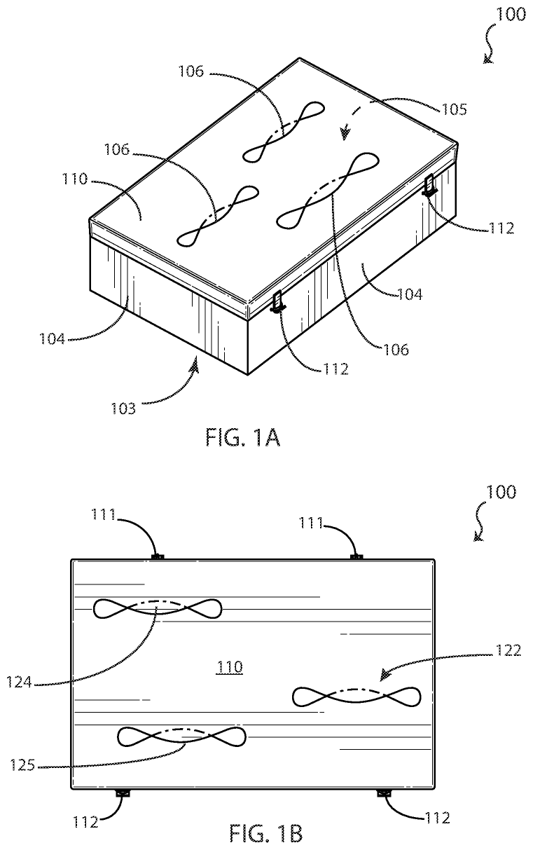

FIGS. 1A-B are top-side perspective and top views of an embodiment of an interactive slow feeder. FIGS. 1A-B show an interactive slow feeder 100. Feeder 100 includes a feed box 102 formed by at least one side 104 coupled to a bottom 103. Feed box 102 has an interior 105 defined by side 104 and bottom 103. Some embodiments, including the example embodiment shown in FIG. 1A, form a rectangular-shaped container, although this is not meant to be limiting. Feed box 102 may have four sides 104, three sides 104, one side 104 (wherein feed box 102 has an oval or cylindrical shape), or more than four sides 104, without limitation, in some embodiments. In some embodiments, including the embodiments shown in the several drawing figures discussed herein, bottom 103 is planar and can be described as substantially “flat.” It is recognized that embodiments of feed box 102 having a flat bottom 103 may rest on the ground or the floor, wherein the horse or other domesticated grazing animal may feed from a head-down position, similar to a natural grazing position. In some other embodiments, however, (not shown herein), bottom 103 is multi-planar and formed from a plurality of adjoining surfaces. In some embodiments, bottom 103 is not planar but rather forms a curvilinear, conical, frustrum, or other non-planar shape. Regardless, side 104 coupled to bottom 103, as shown in the several drawing figures and in some other embodiments not shown, defines and bounds interior 105 such that feed box 102 may hold an animal feed, such as hay or other forage, within interior 105.

The overall dimensions of feed box 102, in some embodiments, are about twenty-four (24) by about thirty-six (36) inches. In some embodiments, the overall dimensions of feed box 102 are about twenty-four (24) by about forty-eight (48) inches. In some embodiments, the overall dimensions of feed box 102 are about eighteen (18) by about forty-eight (48) inches. In some embodiments, the overall dimensions of feed box 102 are about thirty-six (36) inches square. In some embodiments, the overall dimensions of feed box 102 are about forty-eight (48) inches square. The aforementioned dimensions are given by way of example only. A person of skill will recognize that feeders, for example, horse feeders and other grazing animal feeders, come in many different sizes and relative dimensions. Any combination of dimensions suitable for a feed box containing forage for a horse or other large domestic animal are anticipated for feed box 102.

As shown by FIG. 1A, a cover 110 is configured to movably couple to side 104 such that when cover 110 is fitted to side 104 in a closed position (as in FIG. 1A), feed box 102 is closed. In some embodiments, cover 110 is simply removed from side 104, like removing a lid from a box. In some embodiments, cover 110 and side 104 are fitted with at least one hinge 112, wherein cover 110 may be movably coupled to side 104. In some embodiments, hinge 112 does not separate, wherein cover 110 opens to provide access to interior 105 but may not be completely removed from feed box 102. In some embodiments, hinge 112 separates, wherein cover 110 may be completely removed from feed box 102.

In some embodiments, hinge 112 comprises an opening and a J-shaped feature configured to be received by the opening, wherein cover 110 pivotally moves with respect to side 104 at hinge 112. An example embodiment having hinge 112 comprising a J-shaped feature is shown in FIG. 5. FIG. 5 is an underside perspective view of an embodiment of cover 110 coupled to a J-shaped component of hinge 112, wherein hinge 112 comprises separable components and cover 110 has been removed from feed box 102. In some embodiments of hinge 112, including those comprising a J-shaped feature and some other embodiments, Cover 110 is removably coupled to side 104. For example, in some embodiments, hinge 112 may separate by opening cover 110 to a position greater than or equal to about ninety degrees (90°) with respect to side 104, wherein cover 110 may be lifted from side 104, separating cover 110 from feed box 102. A person of skill will recognize that additional configurations of hinge 112 are possible wherein cover 110 may be removably coupled to side 104. In some embodiments, hinge 112 does not separate, wherein cover 110 remains hingedly coupled to side 104 during opening and closing of feed box 102. Some embodiments of interactive slow feeder 100 do not comprise a hinge 112, wherein cover 110 simply is removed from feed box 102 by lifting cover 110 from side 104.

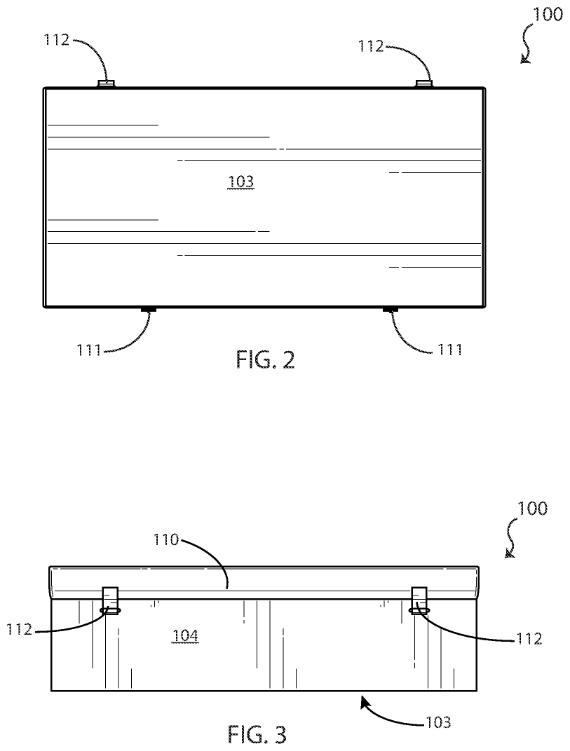

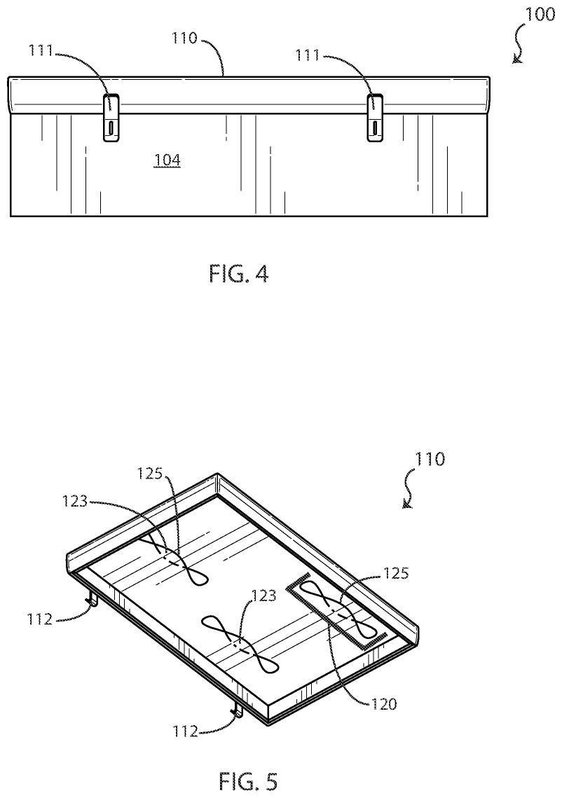

FIG. 2 is a bottom view of an embodiment of an interactive slow feeder, FIG. 3 is a rear view of an embodiment of an interactive slow feeder, and FIG. 4 is a front view of an embodiment of an interactive slow feeder. FIGS. 2-4 show various views depicting the interaction of cover 110 fitted onto side 104 to close the interior 105 of feed box 102. In some embodiments, a latch 111 having components that interact to reversibly secure cover 110 onto feed box 102 in a closed position is coupled to side 104 and cover 110, as shown in FIG. 1B, FIG. 2, and FIG. 4. Latch 111 includes a component coupled to side 104 that detachably interacts with a second component coupled to cover 110. In some embodiments, latch 111 comprises a locking mechanism. In some embodiments, latch 111 receives an external locking mechanism, such as a padlock or a combination lock, for example. Some embodiments of feeder 100 do not comprise latch 111.

FIG. 5 is an underside perspective view of an embodiment of a cover for an interactive slow feeder. FIG. 5 shows cover 110 having a feed port 106, similar to the example embodiment shown in FIGS. 1A-B. Feed port 106 is an opening in cover 110 through which a horse, or other grazing animal, may retrieve forage from interior 105. Unlike a traditional horse feeder, however, the forage may not be visible or openly accessible to the horse or other animal. For example, in the embodiment shown in FIG. 5, and in some other embodiments, cover 110 is fitted with a feature 120 operatively coupled to feed port 106. Feature 120 operates to obstruct feed port 106 partially or completely and reversibly. For example, FIG. 5 shows feature 120 comprising a flap having a lower element 123 and an upper element 124. Feature 120 is configured as a movable obstruction between the horse and the forage held in interior 105 that the horse must determine how best to overcome. In some embodiments of feature 120 formed as a flap, for example, lower element 123 and upper element 124 are deformable with minimal force. In the example embodiment shown in FIG. 5, and in some other embodiments, one or both of lower element 123 and upper element 124 of the flap are formed by overlapping sections of deformable material coupled to or forming all or a portion of cover 110. Examples of such material include canvas cloth, rubberized fabric, a non-woven textile, or any other easily deformable, non-toxic material, without limitation. To access forage from interior 105, an animal, such as a horse, for example, must deform the flaps forming feed port 106 by displacing the flaps with its nose or snout.

Although this may appear trivial, the horse or other grazing animal must, regardless, consider the obstruction created by feature 120 to access the forage held within interior 105 when feeding. This consideration forms an intellectual engagement wherein the horse or other animal interacts with feeder 100 when feeding. The necessary interaction between the animal and interactive slow feeder 100 may provide benefits to the animal, such as providing intellectual stimulation, slowing down the feeding process to better duplicate grazing, and other benefits. Many other examples of features 120 operatively coupled to feed port 106 to movably and intermittently obstruct feed port 106 that must be overcome by an interaction by the horse or other feeding animal are possible. Some additional examples are discussed further herein below. These examples of features 120, however, are not meant to be limiting.

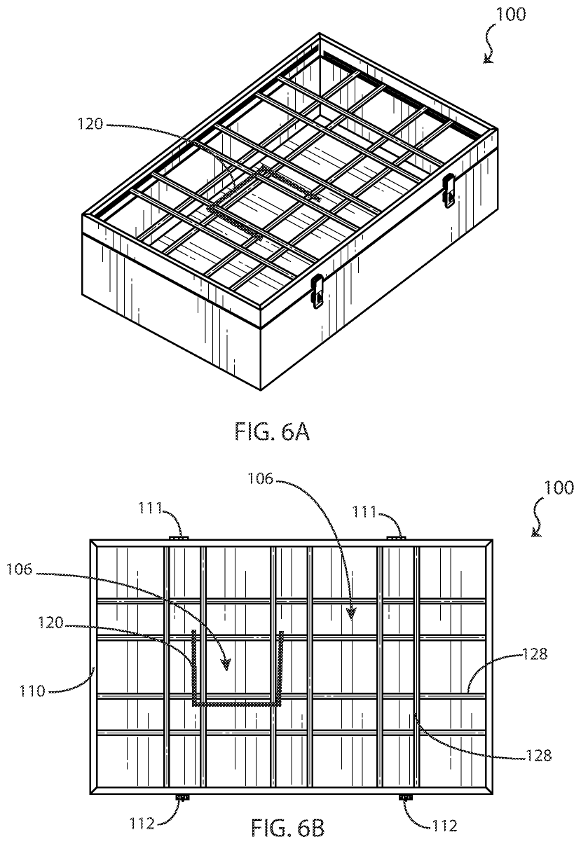

FIGS. 6A-B are top-side perspective and top views of an embodiment of an interactive slow feeder having cover features arranged in a box-grid configuration. FIGS. 6A-B show a cover 110 having a plurality of feed ports 106, wherein each feed port 106 is bounded by an elastic band 128. Multiple elastic bands 128 form a gridwork and define a plurality of feed ports 106. Each feed port 106 is partially obstructed by elastic bands 128 that the horse or grazing animal must displace with its snout to access forage held within interior 105 (not shown) of feeder 100. Feature 120, in the embodiment shown in FIGS. 6A-B, and some other embodiments, is formed from elastic bands 128. The elastic bands 128 are easily displaced by the animal's snout when the animal is feeding and rebound into a position partially obstructing access to interior 105 when the animal removes its snout from feed port 106. Elastic bands 128 may be formed from any soft, elastomeric material, such as natural or synthetic rubber, rubber covered with a woven textile, a woven elastic textile, any combination thereof, or other suitable elastomeric material non-injurious to a horse or other grazing animal.

As discussed herein, feed port 106 is partially or completely obstructed by movable feature 120. In addition to the elastic bands 128 discussed above, Feature 120 can take many forms, as illustrated in the several drawing figures. A variety of illustrative examples of such forms are discussed by way of example below, however this discussion is not intended to be limiting. Persons of skill will recognize, based upon the example embodiments discussed herein, that feature 120 operatively coupled to feed port 106, wherein feature 120 is configured to change feed port 106 from an open position allowing the animal access to interior 105 in response to the animal interacting with feature 120, wherein the animal may remove hay, forage, or other feed from interior 105 is suitable for incorporation by embodiments of interactive slow feeder 100.

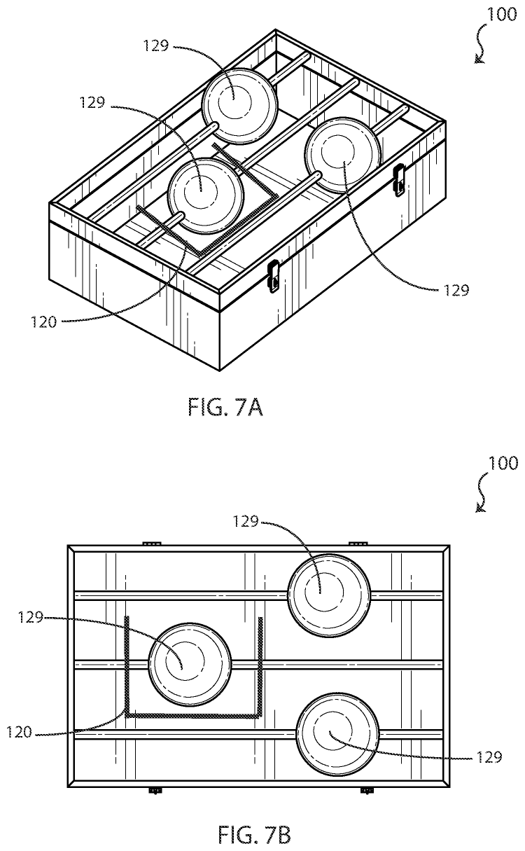

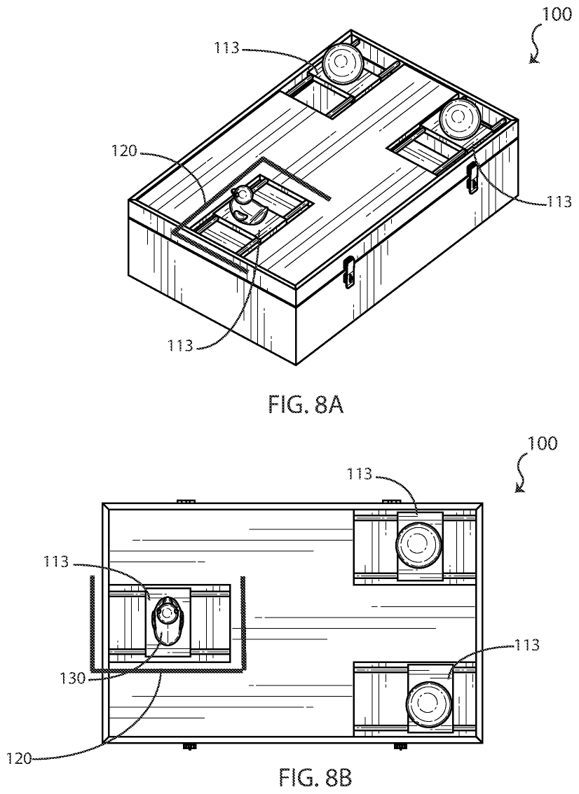

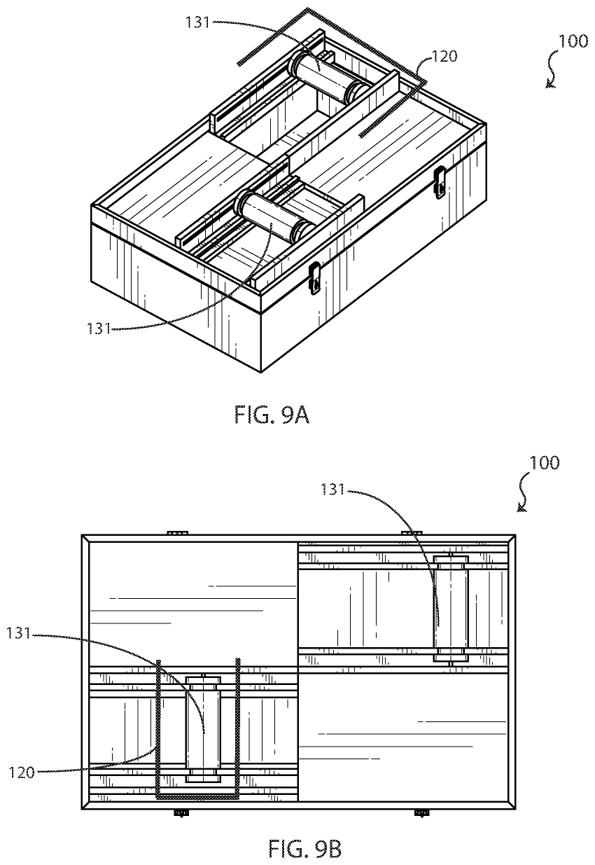

For example, FIGS. 7A-B are top-side perspective and top views of an embodiment of an interactive slow feeder having ball features. FIGS. 8A-B are top-side perspective and top views of an embodiment of an interactive slow feeder with a cover having slide features. FIGS. 9A-B are top-side perspective and top views of an embodiment of an interactive slow feeder with a cover having roller features. In these examples shown in FIGS. 7A-B, 8A-B, and 9A-B, features 120 shaped like a ball 129, an animal toy 130, or a roller 131 respectively are operatively coupled to feed ports 106 such that the feeding animal accesses feed from interior 105 though feed port 106 by moving the coupled feature 120 out of the way. In some embodiments, feature 120 is configured to return to its original position partially or completely obstructing feed port 106 after the animal ceases its physical interaction (i.e., removing its snout from feed port 106) with feature 120. For example, elastic band 128 recoils to its original closed or partially closed position when the animal's snout is removed from port 105. Feature 120 comprising ball 129, slide 113 or roller 131 may comprise an inclined track wherein gravity biases ball 120, slide 113, or roller 131 to return to its original closed position when the animal removes its snout from port 106. In some embodiments, feature 120 does not spontaneously return to its original position, although the horse or other feeding animal may move feature 120 back to its original position.

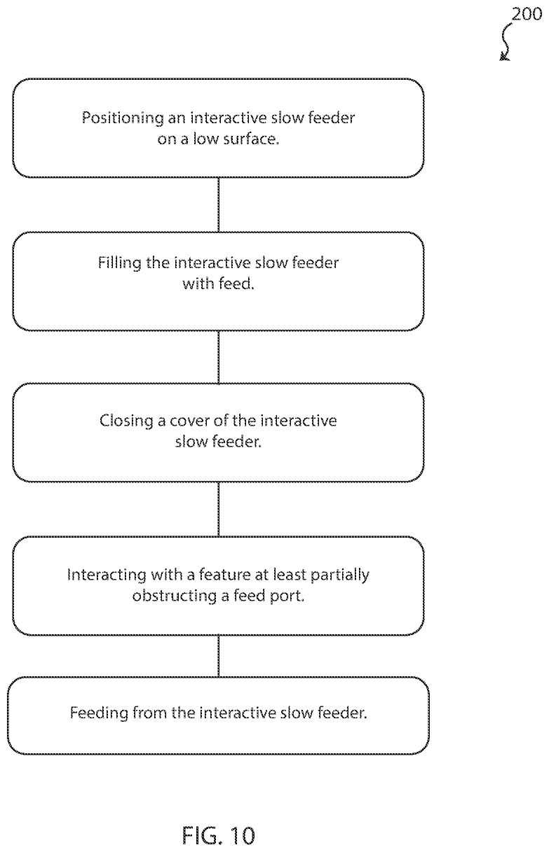

FIG. 10 is a diagram showing steps for a method 200 of simulating a grazing experience for a horse. Specifically, in some embodiments, method 200 simulates a grazing experience for a horse. In some embodiments, method 200 comprises a positioning step 210, a filling step 220, a closing step 230, an interactive step 240, and a feeding step 240.

Positioning step 210, in some embodiments, comprises positioning an interactive slow feeder on a low surface. The low surface should be about or of the same elevation as a surface upon which the horse or grazing animal stands when feeding, such as the ground within a corral, pen, ring, or pasture, for example, or the floor of a barn or similar outbuilding. In some embodiments, a user of the interactive slow feeder may seek to mount the feeder in a more elevated position, such as on a fence or other structure, however this is not desirable. Mounting or otherwise positioning the interactive horse feeder above ground-level interferes with the animal assuming a fully “head-down” position, such as when grazing in a pasture.

Filling step 220, in some embodiments, comprises filling the interactive slow feeder with a feed. The feed, in some embodiments, is hay made from grass, alfalfa, or the like. In some embodiments, the feed comprises grain or other feed. Optimally, however, the feed comprises material similar or related to forage obtained by the animal when grazing, such as grass or hay. This is not intended to be limiting. In some embodiments, filling step 220 comprises filling the interactive slow feeder with any suitable food appropriate for the type of animal interacting with the feeder.

Closing step 230, in some embodiments, comprises closing a cover of the interactive slow feeder. Closing step 230 is simple fitting the cover over a feed box to close an interior of the interactive feeder that has been filled with the feed. The cover comprises one or more feed ports. In some embodiments, the cover is hingedly coupled to the feed box and is not completely detachable from the feed box wherein closing step 230 is accomplished by swinging the cover closed over the feed box by pivoting the cover on a hinge coupled to the feed box and the cover. In some embodiments, the cover is completely removable from the feed box, with or without a hinge that may be un-coupled, wherein closing step 230 comprises fitting the cover onto the feed box thus closing off an interior of the feeder.

Interacting step 240, in some embodiments, comprises interacting with a feature at least partially obstructing a feed port. Interacting step is performed by the horse or other animal desiring to feed from the interactive slow feeder, whereas positioning step 210, filling step 220, and closing step 230 are performed by a human user of the interactive slow feeder. Interacting step 240 is performed by the horse, for example, examining a feed port within the cover of the feeder fitted with a feature completely or partially obstructing the feed port to determine how to interact with the feature, to overcome the obstruction and access the feed, and then physically overcoming the obstruction. In some embodiments, interacting step 240 comprises the animal determining it is safe to physically interact with the feature. In some embodiments, interacting step 240 comprises the animal determining one or more ways to physically interact with the feature to access the feed through the feed port. In some embodiments, interacting step 240 comprises visual examination by the animal. In some embodiments, interacting step 240 comprises sniffing. In some embodiments, interacting step 240 comprises touching the feature, such as with a snout, a hoof, or the like.

In some embodiments, interacting step 240 comprises displacing the feature, wherein the feed port obstruction is relieved sufficient for the animal to access the feed through the feed port. For example, in some embodiments, interacting step 240 comprises displacing a movable flap feature, an elastic band feature, rolling a ball feature, sliding a slider feature, rolling a roller feature, or the like.

Feeding step 250, in some embodiments, comprises the horse or other animal feeding upon the feed through the feed port.

Several embodiments of an interactive slow feeder and method of use have been described herein. The interactive feeder allows for intellectual and physical interaction by the animal with the feeder, so as to require a level of intellectual and physical activity by the animal greater than simply eating forage from a feed box or trough. The intellectual and physical interaction may partially re-create certain intellectual and physical experiences of the animal when grazing, for example.

The embodiments and examples set forth herein were presented in order to best explain the present invention and its practical application, and to thereby enable those of ordinary skill in the art to make and use the invention. However, those of ordinary skill in the art will recognize that the foregoing description and examples have been presented for the purpose of illustration and example. The description as set forth is not intended to be exhaustive or to limit the invention to the precise form disclosed. Many modifications and variations are possible, in light of the teachings herein above.

What is claimed is:

1. An interactive horse feeder comprising:
a feed box having an interior defined by at least one side and configured to hold an animal feed;
a cover configured to moveably interact with the at least one side to fully enclose the interior and having a feed port in communication with the interior; and
a feature operatively coupled to the feed port, wherein the feature is configured to change the feed port between a closed position restricting access to the interior to an open position allowing access to the interior in response to an animal interaction with the feature, wherein the animal may remove the animal feed from the interior.

2. The interactive horse feeder of claim 1, further comprising a bottom coupled to the at least one side opposite the cover.

3. The interactive horse feeder of claim 1, wherein the cover has a plurality of feed ports.

4. The interactive horse feeder of claim 3 having a plurality of features.

5. The interactive horse feeder of claim 4 wherein each of the plurality of features is operatively coupled to only one of the plurality of feed ports.

6. The interactive horse feeder of claim 4, wherein at least one of the plurality of features is operatively coupled to more than one of the plurality of feed ports.

7. The interactive horse feeder of claim 1, wherein the cover is hingedly coupled to the at least one side.

8. The interactive horse feeder of claim 1, wherein the cover is slidably coupled to the at least one side.

9. The interactive horse feeder of claim 1, wherein the cover is removable from the feed box.

10. The interactive horse feeder of claim 1, wherein the feature is a flap covering the feed port and formed by a flexible lower element partially overlapping or overlapped by a flexible upper element.

11. The interactive horse feeder of claim 10, wherein the flap has a substantially linear edge.

12. The interactive horse feeder of claim 10, wherein the flap has a substantially arcuate edge.

13. The interactive horse feeder of claim 1, wherein the feature is a slidably coupled to the feed port.

14. The interactive horse feeder of claim 1, wherein the feature is hingedly coupled to the feed port.

15. The interactive horse feeder of claim 1, wherein the feature comprises an animal toy.

16. A method of simulating a grazing experience to a horse comprising: positioning an interactive slow feeder on a low surface; filling the interactive slow feeder with feed; closing a cover of the interactive slow feeder; interacting with a feature at least partially obstructing a feed port; and feeding from the interactive slow feeder.
